(19) United States
(12) Patent Application Publication
(10) Pub. No.: US 2006/0106662 A1
(43) Pub. Date: May 18, 2006

(54) Rendering variable data at a point-of-purchase

(75) Inventors: Galo Gimenez Palop, Bigues i Riells (ES); Luca Chiarabini, Sant Cugat (ES); Sergio Jarne Casbas, Sant Cugat del Valles (ES); Christian Barckhahn Delpiano, Sant Cugat del Valles (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/988,143

(22) Filed: Nov. 12, 2004

(51) Int. Cl. G06F 17/21

(52) U.S. Cl. 705/8; 715/523

(57) ABSTRACT

A method according to an embodiment is used to render materials at a rendering station. In an embodiment, a job production subsystem may receive campaign data, which defines a promotional campaign, and generate multiple job documents, based on the campaign data. At least some of the multiple job documents identify one or more variable data elements. Multiple files, which include information from the multiple job documents, are delivered to multiple rendering stations. A rendering station receives a file, and renders it by causing a display device to display the one or more variable data elements. In an embodiment, the rendering station may be a point-of-purchase (PoP) rendering station.

### BACKGROUND

In the retail industry, various types of promotional techniques are used to attract consumers to particular products and brands. A large percentage of consumer purchasing decisions are made in-store, or at the point-of-purchase (PoP). Accordingly, many retail promotions include PoP materials. For example, promotional signs (i.e., “signage”) are often used at PoP locations to promote products and brands.

Traditional PoP material printing processes sometimes result in significant amounts of wasted time, money, and materials. For example, for some promotions, excess quantities of signage are printed, and the excess materials ultimately are discarded unused. In addition, some signage may never be used after it reaches a retail outlet because the signage arrived at the wrong time, the signage needed resources to set it up, which were being used to look after customers, or the signage failed to comply with branding guidelines. Printed signage also may include errors, such as pricing/promotion mismatches, for example.

In addition, a protracted and time-consuming process may be used, in order to include attention-grabbing elements in retail signage. For example, signage that includes brand advertising messages, color or graphics may take substantial amounts of time to design, approve, print, and distribute. The significance of PoP consumer decision-making is driving retailers and others to develop timelier and less wasteful ways of producing PoP promotional materials.

### BRIEF DESCRIPTION OF THE DRAWINGS

Like-reference numbers refer to similar items throughout the figures and:

FIG. 1 is a simplified block diagram of a promotional material rendering system, in accordance with an example embodiment;

FIG. 2 illustrates an example of a rendering station in a retail context, in accordance with an example embodiment;

FIG. 3 illustrates an example of a slide displayed on a rendering station, in accordance with an example embodiment;

FIG. 4 illustrates a simplified block diagram of a rendering station, in accordance with an example embodiment; and

FIG. 5 is a flowchart of a method for rendering promotional materials, in accordance with an example embodiment.

### DETAILED DESCRIPTION

Embodiments of the inventive subject matter include methods and apparatus for rendering materials. As used herein, the term “render” means to output a representation of one or more perceptible elements on an output device, referred to herein as a “rendering station.” This includes, but is not limited to, printing one or more sheets on a printer, electronically displaying one or more slides on a display device, outputting one or more audio clips on a speaker, and/or outputting multimedia materials on a multimedia output device.

In an embodiment, rendering is performed by rendering stations that are located in proximity to point-of-purchase (PoP) locations. PoP locations include, but are not limited to, physical locations within stores (e.g., at checkout stands, on aisle shelves, at end-caps, in window displays, etc.) or other sales outlets. In an embodiment, rendering is performed by a rendering station, which receives the information to be rendered from other portions of a rendering system.

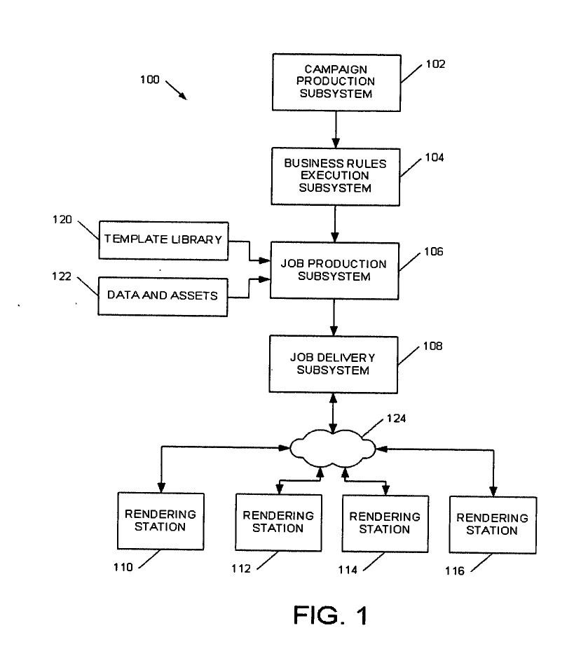

A rendering station may include one or more output mechanisms, including but not limited to, a display device, a shelf-edge display, a speaker, a printer, a cluster of printers, a digital press, combinations of these output mechanisms, or other types of single media or multimedia rendering mechanism. Embodiments of rendering systems geared toward rendering promotional materials are described, below, in conjunction with FIG. 1. It is to be understood that the description of a rendering system in the promotional material context is not meant to be limiting, but instead embodiments may be used to render information in other contexts, as well.

FIG. 1 is a simplified block diagram of a promotional material rendering system 100, in accordance with an embodiment. System 100 includes a campaign production subsystem 102, a business rules execution subsystem 104, a job production subsystem 106, a job delivery subsystem 108, and one or more rendering stations 110, 112, 114, 116. The term “subsystem” is defined herein to mean a centralized or distributed computing apparatus, which includes one or more processors. In various embodiments, subsystems 102, 104, 106, and 108 may use distinct computing apparatus, or some combinations of subsystems 102, 104, 106, 108 may use common computing apparatus.

In an embodiment, a manufacturer, distributor, wholesaler, retailer or other entity may centrally define a campaign that includes promotional materials (e.g., advertisements) to be rendered at PoP locations. As will be described below, system 100 may include variable data elements in the promotional materials, in order to customize the materials based on demographics or other variables (e.g., a store name, location, inventory, price, discount, local language, etc.).

Campaign production subsystem 102 may include, for example, an enterprise resource planning (ERP) system and/or a customer relationships management (CRM) system. In an embodiment, campaign production subsystem 102 produces “campaign data,” which may be used to define a promotional campaign. More specifically, in an embodiment, campaign data may specify combinations of various perceptible elements, such as text elements, multimedia elements (e.g., video, animation, and/or audio clips), photographic elements, graphical elements (e.g., logos or other rendered images), backgrounds, and other elements specifying the location (on a page or slide), appearance, or time constraints for rendering the perceptible elements.

Perceptible elements may include “fixed elements” and “variable elements.” A fixed element is an element that may appear substantially the same on a page or slide, regardless of demographic or other variables associated with a destination rendering station. A variable element is an element that may appear differently on a page or slide for destination rendering stations having different demographic or other variables. For example, a variable data element within an advertisement may include first information when it is rendered in a first location and second, different information when it is rendered in a second location. For other examples, variable data elements may cause an advertisement to be rendered differently based on the identity of a business entity (e.g., a grocery store chain) associated with the rendering station, the physical location where it is rendered (e.g., a store address), local or regional promotions (e.g., promotions from the store where an advertisement is rendered), price, store inventory, and local language, among other things. Elements may be tagged to describe the rules that determine which elements may be imported from a database.

Business rules execution subsystem 104 receives campaign data as a data stream (e.g., in XML format), in a file format, or in another format. In an embodiment, the business rules execution element 104 applies a set of filters or “flow actions” to the campaign data. For example, but not by way of limitation, a set of filters may be implemented as a configurable SAX (simple API for XML) filter chain, or the like, in which events are passed from one filter event handler to another. In an embodiment, a filter may be implemented in XSLT, Java, or another language, and appended to a print flow by system integrators.

Each filter acts on the campaign data, and applies one or more business rules. For example, but not by way of limitation, a filter may apply target language restrictions, providing translations to the local language for a destination rendering station. As another example, a filter may ensure that proper branding is being used in conjunction with an advertisement. Numerous other types of business rules and filters may be applied.

Different business rules may be applied to campaign data depending on the type of promotional materials associated with the campaign. For example, but not by way of limitation, business rules execution subsystem 104 may execute different flow actions for a personalized direct marketing campaign than it would execute for centralized production of PoP materials.

In an embodiment, business rules execution subsystem 104 generates “filtered” campaign data, which specifies one or more perceptible elements that may define a campaign. The filtered campaign data is sent to and received by job production subsystem 106. Job production subsystem 106 generates one or more “jobs” from the filtered campaign data, in an embodiment. As used herein, a “job” means a document or file that identifies and/or includes the elements associated with a distinct set of pages or slides to be rendered.

In conjunction with generating a job, job production subsystem 106 may group job elements together, in an embodiment. For example, job production subsystem 106 may separate job elements for different pages or slides, in an embodiment. For another example, job elements that are destined for different locations or which have different priority levels may be separated into distinct job groups. Other criteria may be used to group job elements together, as well, such as product types, the number of pages or slides in a job, and many other criteria. In other embodiments, job elements are not grouped.

Job production subsystem 106 generates one or more job documents, where a job document identifies a set of job elements (e.g., the job elements associated with a group). In various embodiments, a job document may include single-media or multimedia content. In an embodiment, a job document is formed from a layout template, which enables the layout of a page or slide to be described in terms of its constituent elements.

For example, but not by way of limitation, a job document may be generated as a personalized printing markup language (PPML) template, in an embodiment. PPML is a standardized language, which does not itself specify a content format, but instead provides metadata about the content structure and layout. PPML may be applied to a data stream, producing as a result a PPML template. A PPML template may contain a design and rules to apply to data, in order to generate a personalized document (i.e., a document that includes one or more variable data elements). Besides PPML, other standardized or proprietary languages or protocols may be used, in other embodiments.

Job production subsystem 106 obtains a template from a template library 120 (e.g., a PPML template library), in an embodiment. Job production subsystem 106 then adds references (e.g., pointers), data, and/or assets to the template, in an embodiment, to identify the fixed and/or variable elements within a job document. For example, job production subsystem 106 may create pointers to data and assets that are stored within a data and asset database 122. In an embodiment, job production subsystem 106 produces one or more job documents, each of which may include a template with its data section substantially filled with data, assets, and/or pointers.

Numerous types of elements may exist, including but not limited to, images (still and moving), multimedia elements, audio clips, backgrounds, and font files, among other things. Elements may be represented using various formats. For example, a layout template may include elements in one or more formats that include, but are not limited to, image formats (e.g., joint photographic experts group (JPEG), tagged image file format (TIFF), bitmap (BMP), graphics interchange format (GIF), animated GIF, PNG, EMF, WMF, PCX, TGA, J2K, RAS, etc.), multimedia formats (e.g., motion picture experts group (MPEG), audio video interleave (AVI), Windows media video (WMV), advance streaming format (ASF), real media video, etc.), audio formats (MPEG layer 3 (MP3), WAV, PCM, Windows media audio (WMA), CDA, ALF2, ADPCM, GSM, DSP, A-LAW, U-LAW, Ogg Vorbis, etc.), font file formats (e.g., true type font (TTF), etc.), document formats (e.g., portable document format (PDF)), and other formats.

Job production subsystem 106 sends job documents to job delivery subsystem 108, which receives the job document and delivers an associated “station-specific job file” or “station file” to one or more rendering stations (e.g., stations 110, 112, 114, 116), in an embodiment. A station file includes an electronic document which identifies (i.e., points to or includes) one or more fixed elements and/or variable data elements, in and embodiment.

A station file may identify one or more visually-depictable elements, meaning that they may be rendered to a display device, in an embodiment. In another embodiment, a station file may identify one or more audio clips, which may be rendered to a speaker. In still another embodiment, a station file may identify multimedia content (e.g., both visually-depictable and audio elements), which may be rendered to a multimedia output device.

In an embodiment, delivery also may include defining a delivery service for each rendering station for which a job is destined. A “delivery service” is a component that translates a job document (if necessary) into a differently formatted document, which becomes the station file. The translation of the document may depend on the destination rendering station's hardware and supported protocols, among other things. For example, but not by way of limitation, a rendering station may be a digital front end, a digital press, a printer, an email system, a fax machine, a display device, and/or a multimedia output device, to name a few. Each of these types of rendering stations may render jobs that are formatted a certain way. Accordingly, job delivery subsystem 108 may translate a job document to a format appropriate for the rendering station type.

In some cases, job delivery subsystem 108 may deliver a job document (e.g., a PPML template) without translation. In other words, a station file may be a PPML template. In another embodiment, job delivery subsystem 108 may translate a PPML template into a PDF file, prior to delivery. This is desirable for delivery to a device that may have fewer or different resources than are used to render a PPML template. Accordingly, a station file may be a PDF file or another type of document rendering file. In another embodiment, job delivery subsystem 108 may deliver a ticket (e.g., a job definition (JDF) ticket) to a rendering station, which describes the intent of the job. The ticket may include references to the assets (e.g., a PPML template) needed to process the job. In addition, job delivery subsystem 108 may support other delivery services, such as an export to folder delivery service and/or the delivery of jobs to display-type rendering stations (e.g., flat panel display rendering stations), among other services.

In various embodiments, job delivery subsystem 108 also may perform one or more other processes. For example, but not by way of limitation, job delivery subsystem 108 may support creation and setup of rendering station capabilities (e.g., the delivery service used), global print station queue management (e.g., resubmit, change priority, move or pause jobs, etc.), routing between rendering stations, and/or job status and rendering station monitoring, to name a few. Accordingly, a bi-directional link may exist between job delivery system 108 and rendering stations 110, 112, 114, 116.

In an embodiment, job delivery subsystem 108 automatically delivers station files to rendering stations. In another embodiment, a rendering station may occasionally poll the job delivery subsystem 108 for new jobs to render.

Job delivery subsystem 108 may deliver a station file over one or more wired or wireless networks (e.g., network 124) or other communication channels. A delivery network may include, for example but not by way of limitation, a local area network (LAN) or a wide area network (WAN). Network 124 may include various types of wired or wireless nodes, such as other computers, satellites, relay stations, and/or routing stations, to name a few. In an alternate embodiment, job delivery subsystem 108 may deliver a station file over a dedicated channel or connection with a rendering station.

One or more rendering stations 110, 112, 114, 116 receive the station files, and render them according to their contents. A rendering station 110, 112, 114, 116 may include, for example, a display device (e.g., a CRT or flat-panel display), a multimedia output device (e.g., including a display device and a speaker), a printer, a digital front end, a digital press, an email system, a fax machine, or another type of rendering station. Rendering stations 110, 112, 114, 116 may be located in close proximity to each other (e.g., within a single store), or may be located far from each other (e.g., in different countries). For example, in various embodiments, rendering stations 110, 112, 114, 116 may be located in stores, offices, print service provider facilities, and other locations.

A rendering station 110, 112, 114, 116 receives and processes a station file. In an embodiment, a station file (e.g., a PPML template or a PDF file) includes substantially all the information that the rendering station needs to render the job. In another embodiment, a station file may include information that enables a rendering station to download one or more fixed or variable data elements (e.g., data and assets identified in the station file). For example, in an embodiment, a station file may include a PPML template, and a rendering station may download and store (e.g., cache) assets referred to in the PPML template. The rendering station may then translate the PPML template and the downloaded information into a format (e.g., a PDF file) that may be readily rendered.

A station file may be rendered using a document output program. In an embodiment, a station file is rendered by causing a display device to display one or more visually-depictable elements. For example, rendering a station file may result in one or more slides to be rendered in sequence on a display device or a multimedia device.

In an embodiment, rendering stations may include display devices located at PoP locations within retail or wholesale stores. For example, display-type rendering stations (e.g., flat panel displays) may be located on store shelves, at end-caps, in proximity to check-out stands, and at other store locations. Further, a multimedia-type rendering station (e.g., a multimedia output device) may include a display device and one or more speakers, which enable audio elements identified within a station file to be output. Display-type and multimedia-type rendering stations may render one or more visually-depictable, fixed and/or variable data elements by causing a display device associated with the rendering station to display the elements.

An example for rendering jobs is now given to further illustrate embodiments of the inventive subject matter. In this example, a manufacturer, referred to as XYZ Corp. may desire to create a promotional campaign. The campaign may include placing several products, referred to as XYZ Soup, XYZ Cereal, and XYZ Nuts, on sale at 10% below the suggested retail price for those products. The campaign may be applicable to stores for a first grocery chain, located in the United States, and to stores for a second grocery chain, located in Japan. The first chain is referred to as US Chain, and the second chain is referred to as JPN Chain. The promotional materials for the campaign may be specified as multimedia slides, to be output by multimedia output devices located on store shelves proximate to the products.

In an embodiment, XYZ Corp. may generate raw campaign data describing the campaign, using campaign production subsystem 102. In an embodiment, the campaign data may specify one or more variable data elements. For example, a variable data element may indicate that the product descriptions for XYZ Soup, XYZ Cereal, and XYZ Nuts should appear in the language of the country in which the destination rendering stations are located. Another variable data element may indicate that an identity of the chain should appear in the upper-left corner of the display screen.

The raw campaign data may be received and processed by a business rules execution subsystem 104. Business rules execution subsystem 104 may apply various filters to the campaign data, in order to produce filtered campaign data. For example, business rules execution subsystem 104 may translate an English version of the product descriptions into Japanese, resulting in both an English version and a Japanese version of the product descriptions as part of the processed campaign data.

Job production subsystem 106 may receive the filtered campaign data, and may then separate and group job elements pertaining to distinct parts of the campaign. For example, job production subsystem 106 may separate all elements pertaining specifically to advertising XYZ Soup from job elements that advertise XYZ Cereal and XYZ Nuts. Further, job production subsystem 106 may group elements that are in English or Japanese with their appropriate jobs. Job production subsystem 106 additionally may generate multiple distinct job documents from the grouped information, using templates, data, and assets available to job production subsystem 106.

For example, job production subsystem 106 may create some or all of the following job documents: 1) an English document for XYZ Soup; 2) a Japanese document for XYZ Soup; 3) an English document for XYZ Cereal; 4) a Japanese document for XYZ Cereal; 5) an English document for XYZ Nuts; and 6) a Japanese document for XYZ Nuts. The first job document may include data elements for the US Chain logo, the XYZ Soup logo, an English description of XYZ Soup, a discounted price, a video of a child eating XYZ Soup, and an English audio clip talking about the product. The second job document may include data elements for the JPN Chain logo, the XYZ Soup logo, a Japanese description of XYZ Soup, the discounted price, the video of the eating child, and a Japanese audio clip talking about the product. Accordingly, each job document may include variable data elements, based on multiple factors such as the target store, the product being advertised, local and regional language (or other demographics), a store aisle, a store shelf, and a rendering station type, among other things.

The job documents are received by job delivery subsystem 108. Job delivery subsystem 108 may define one or more delivery services, based on the destination rendering station types, and may translate the job documents into other formats, if necessary. Further, job delivery subsystem 108 may deliver the job documents (translated or not) to the destination rendering stations. Delivery may be performed immediately after processing is completed, or may be performed proximate to times when the jobs are to be rendered.

Rendering stations 110, 112, 114, 116 receive station files and render the files at the appropriate times. For example, rendering station 110 may be located in a US Chain store on a shelf proximate to XYZ Nuts. Desirably, rendering station 110 receives a station file that includes the English version of the XYZ Nuts advertisement. Conversely, rendering station 116 may be located in a JPN Chain store on a shelf proximate to XYZ Soup. Desirably, rendering station 116 receives a station file that includes the Japanese version of the XYZ Soup advertisement.

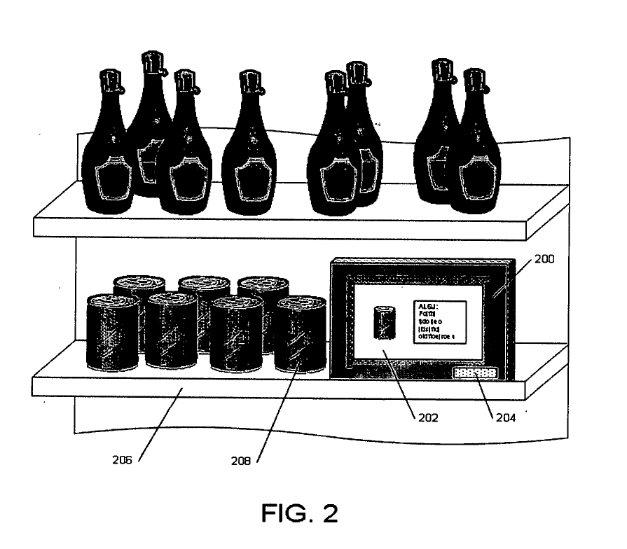

FIG. 2 illustrates an example of a rendering station 200 in a retail context, in accordance with an embodiment. Rendering station 200 includes a flat-panel display screen 202 and a speaker 204. Rendering station 200 may be located on a store shelf 206, in proximity to a product 208.

Rendering station 200 may receive one or more station files over a wired or wireless connection (not illustrated) to a network (e.g., network 124, FIG. 2) and/or a job delivery subsystem (e.g., subsystem 108, FIG. 1). A received station file may identify and/or include, among other things, one or more visually-perceptible elements and/or one or more audio elements. Visually-perceptible elements may be rendered on screen 202 and audio elements may be rendered through speaker 204. A set of simultaneously-rendered elements associated with a station file are referred to herein as a “slide.” A station file may include job elements for one or more slides.

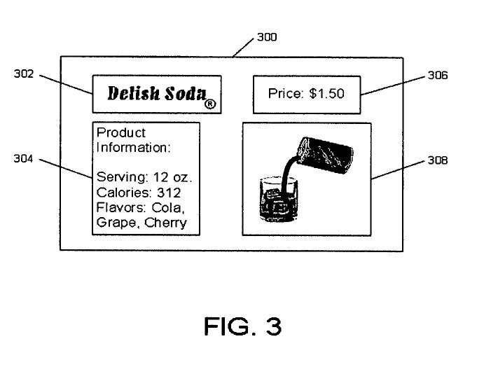

FIG. 3 illustrates an example of a slide 300 displayed by a display-type rendering station, in accordance with an embodiment. A rendering station may display slide 300 by rendering objects identified within a station file. In an embodiment, a slide may include a number of different types of elements. For example, a slide may include one or more graphical elements (e.g., logo 302), one or more text elements (e.g., product information text 304 and price element 306), one or more video elements (e.g., video element 308), and/or one or more other types of visually-perceptible elements. Some or all of the elements may be fixed elements and some may be variable data elements.

In an embodiment, a rendering station that includes a display may be located within a store, in proximity to multiple products. The rendering station may receive and render multiple station files, some or all of which pertain to one or more of the proximate products. In an embodiment, a rendering station may queue multiple slides for one-time or repeated rendering. Accordingly, a rendering station may render a first slide relating to a first brand of soda that is proximate to the rendering station. The rendering station may then render a second slide relating to a second brand of soda that is proximate to the rendering station. The rendering station may then render a third slide that includes a general advertisement for the store. The rendering station may then repeat the rendering of the first slide, and so on.

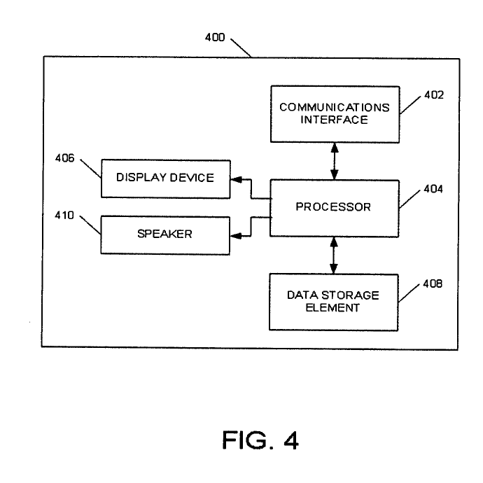

FIG. 4 illustrates a simplified block diagram of a rendering station 400, in accordance with an embodiment. Rendering station 400 includes at least one communications interface 402, at least one processor 404, and at least one display device 406, and a data storage element 408, in an embodiment. In another embodiment, rendering station 400 is a multimedia output device, and further includes at least one speaker 410.

Communications interface 402 may receive one or more files, which include information identifying one or more visually-depictable, variable data elements. As described previously, interface 402 may receive a file from a wired or wireless network (e.g., a LAN or WAN) or another type of wired or wireless link.

Processor 404 is operatively coupled to communications interface 402. Processor 404 process the received file and causes display device 406 to display the one or more visually-depictable, variable data elements. Similarly, processor 404 may cause speaker 410 to output one or more audio clips identified in the file. In an embodiment, processor 404 also may download the one or more visually-depictable, variable data elements, and store them in data storage element 408. In still another embodiment, processor 404 may also translate the file from a personalized printing markup language template into a portable document format prior to rendering.

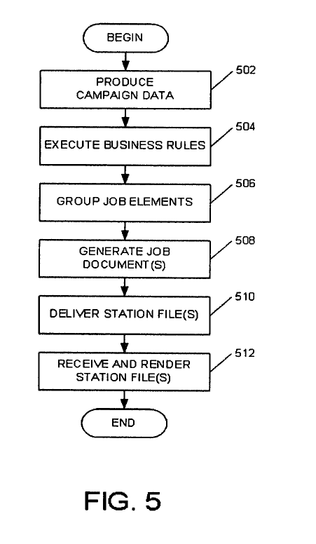

FIG. 5 is a flowchart of a method for rendering promotional materials, in accordance with an embodiment. The method begins, in block 502, when campaign data is produced. In an embodiment, campaign data may be produced by a campaign production subsystem (e.g., subsystem 102, FIG. 1), which may include, for example, an ERP and/or CRM system.

In block 504, one or more business rules may be executed for the campaign data. In an embodiment, a business rules execution subsystem (e.g., subsystem 104, FIG. 1) receives the campaign data, and applies a set of filters or flow actions to the campaign data. Each filter acts on the campaign data, and applies one or more business rules. In an embodiment, the business rules execution subsystem generates filtered campaign data.

In block 506, one or more job elements may be grouped. Job element grouping may be performed by a job production subsystem (e.g., subsystem 106, FIG. 1), in an embodiment. This may include separating elements that form distinct parts of a campaign, in an embodiment, and grouping them together. Alternatively, some or all job elements may not be grouped, and may remain as discrete elements.

In block 508, one or more job documents may be generated from the grouped or discrete job elements. In an embodiment, job document generation also may be performed by the job production subsystem (e.g., subsystem 106, FIG. 1). A job document includes a set of job elements (e.g., the job elements associated with a group). In an embodiment, a job document is formed by selecting a template and filling it with data, assets, and/or pointers thereto. For example, but not by way of limitation, a job document may be generated using a PPML template or another type of template. In an alternate embodiment, a job document may be generated in another type of format, such as a PDF file, for example.

In block 510, information within one or more of the job documents may be delivered to one or more destination rendering stations. Job information delivery may be performed by a job delivery subsystem (e.g., subsystem 108, FIG. 1). In an embodiment, this may include defining a delivery service for each rendering station to which the job information is delivered and, in some cases, translating a job document to a target format, resulting in a station-specific job file or station file. In other cases, a station file may be in the same format as the job document. A station file includes an electronic document which identifies (i.e., points to or includes) one or more visually-depictable elements, in and embodiment.

In block 512, one or more destination rendering stations (e.g., stations 110, 112, 114, 116, FIG. 1) may receive and render the station files. A rendering station may render a station file by outputting, to an output device (e.g., a display device, speaker, etc.), information corresponding to one or more elements identified within the station file. In an embodiment, a rendering station may render a particular station file as long as the station file is valid and has not expired. Accordingly, a rendering station may render a valid station file continuously, for a period of time, or periodically, in various embodiments.

To determine when and whether a particular station file is valid, a station file may further include time information such as, for example, a start time, a stop time, a number of iterations, and/or a duration. The time information may enable a rendering station to know when and/or for how long to render a particular station file. In alternate embodiments, a rendering station may render a particular station file once or may render a station file continuously until another station file is received.

In still another embodiment, a rendering station may render a particular station file in a sequence with other valid station files. For example, a rendering station may have several valid station files queued in a circularly accessible manner. The rendering station may cycle through the valid station files, adding and deleting other station files to the queue as they become valid or invalid, respectively. After rendering a station file in accordance with its timing constraints, if any, the method then ends.

The various procedures described herein can be implemented in hardware, firmware or software. A software implementation could use microcode, assembly language code, or a higher-level language code. The code may be stored on one or more volatile or non-volatile computer-readable media during execution or at other times. These computer-readable media may include hard disks, removable magnetic disks, removable optical disks, magnetic cassettes, flash memory cards, digital video disks, Bernoulli cartridges, random access memories (RAMs), read only memories (ROMs), and the like.

Although the Figures illustrate various processes as occurring in specific sequences, it would be apparent to one of skill in the art that the orders of the process blocks could be modified while still achieving the same results. Accordingly, modifications in the sequences of processing blocks are intended to fall within the scope of the inventive subject matter.

Thus, various embodiments of a method, apparatus, and system have been described for rendering materials. The foregoing description of specific embodiments reveals the general nature of the inventive subject matter sufficiently that others can, by applying current knowledge, readily modify and/or adapt it for various applications without departing from the general concept. Therefore, such adaptations and modifications are within the meaning and range of equivalents of the disclosed embodiments.

The phraseology or terminology employed herein is for the purpose of description and not of limitation. Accordingly, the inventive subject matter embraces all such alternatives, modifications, equivalents and variations as fall within the spirit and broad scope of the appended claims.

What is claimed is:

1. A method comprising:
a job production subsystem receiving campaign data, which defines a promotional campaign;
the job production subsystem generating a job document, based on the campaign data, wherein the job document identifies one or more visually-depictable, variable data elements;
a job delivery subsystem delivering a file, which includes information from the job document, to a rendering station;
the rendering station receiving the file, wherein the rendering station includes a display device; and
the rendering station rendering the file by causing the display device to display the one or more visually-depictable, variable data elements.

2. The method of claim 1, further comprising:
a business rules execution subsystem applying one or more business rules to the campaign data prior to the job production subsystem generating the job document.

3. The method of claim 1, wherein generating the job document further comprises generating a personalized printing markup language template, and wherein delivering the file comprises delivering the personalized printing markup language template.

4. The method of claim 1, wherein generating the job document further comprises generating a personalized printing markup language template, and the method further comprising:
translating the personalized printing markup language template into a portable document format file, and wherein delivering the file comprises delivering the portable document format file.

5. The method of claim 1, wherein generating the job document comprises generating the job document to include multimedia content, and wherein rendering the file comprises rendering the multimedia content to a multimedia output device.

6. A method comprising:
receiving an electronic document by a point-of-purchase rendering station, wherein the rendering station includes a display device, and wherein the electronic document identifies one or more variable data elements; and
rendering the electronic document by causing the display device to display the one or more variable data elements.

7. The method of claim 6, wherein the electronic document includes a personalized printing markup language template, which identifies the one or more variable data elements.

8. The method of claim 6, further comprising:
downloading and storing the one or more variable data elements.

9. The method of claim 6, further comprising:
translating the electronic document into a portable document format, prior to rendering.

10. The method of claim 6, wherein the electronic document includes a portable document format file.

11. The method of claim 6, wherein the electronic document identifies multimedia content, and wherein the display device forms a portion of a multimedia output device, and wherein rendering the electronic document further comprises causing the multimedia output device to output the multimedia content.

12. A method comprising:
receiving a personalized printing markup language template, which identifies one or more visually-depictable, variable data elements;
translating the personalized printing markup language template into a portable document format; and
rendering the one or more visually-depictable, variable data elements on a rendering station by causing a display device associated with the rendering station to display the one or more visually-depictable, variable data elements.

13. The method of claim 12, further comprising:
downloading and storing the one or more visually-depictable, variable data elements.

14. The method of claim 12, wherein the personalized printing markup language template identifies multimedia content, and wherein the rendering station includes a multimedia output device, and wherein rendering further comprises causing the multimedia output device to output the multimedia content.

15. A method comprising:
receiving campaign data, which defines a promotional campaign;
generating multiple job documents, based on the campaign data, wherein at least some of the multiple job documents identify one or more visually-depictable, variable data elements; and
delivering multiple files, which include information from the multiple job documents, to multiple rendering stations for rendering on display devices associated with the rendering stations.

16. The method of claim 15, wherein generating the multiple job documents comprises generating the multiple job documents so that at least some of the multiple job documents include multimedia content.

17. The method of claim 15, wherein generating the multiple job documents includes generating multiple personalized printing markup language templates, and wherein the multiple files include the multiple personalized printing markup language templates.

18. The method of claim 15, wherein generating the multiple job documents comprises generating multiple personalized printing markup language templates.

19. The method of claim 15, wherein generating the multiple job documents includes generating multiple personalized printing markup language templates, the method further comprising:
translating at least some of the multiple personalized printing markup language templates into one or more portable document format files, wherein the multiple files include the one or more portable document format files.

20. An apparatus comprising:
a communications interface to receive a file, which includes information identifying one or more visually-depictable, variable data elements;
a processor, coupled to the communications interface, to process the file and to cause a display device to display the one or more visually-depictable, variable data elements; and
the display device, coupled to the processor.

21. The apparatus of claim 20, further comprising:
a speaker, coupled to the processor, to output one or more audio clips identified in the file.

22. The apparatus of claim 20, wherein the processor is further to download the one or more visually-depictable, variable data elements, and the apparatus further includes:
a data storage element, coupled to the processor, to store the one or more visually-depictable, variable data elements.

23. The apparatus of claim 20, wherein the processor is further to translate the file from a personalized printing markup language template into a portable document format prior to rendering.

24. A system comprising:
a job production subsystem to receive campaign data, which defines a promotional campaign, and to generate a job document, based on the campaign data, wherein the job document identifies one or more visually-depictable, variable data elements;
a job delivery subsystem to deliver a file, which includes information from the job document, to at least one rendering station;
the at least one rendering station to receive the file, wherein the rendering station includes a display device, and the at least one rendering station is further to render the file by causing the display device to display the one or more visually-depictable, variable data elements.

25. The system of claim 24, further comprising:
a campaign production subsystem to produce the campaign data.

26. The system of claim 24, further comprising:
a business rules execution subsystem to apply one or more business rules to the campaign data prior to the job production subsystem generating the job document.

27. An apparatus comprising:
a means for receiving a file, which includes information identifying one or more visually-depictable, variable data elements;
a means for processing the file, coupled to the means for receiving, to process the file and to cause a display device to display the one or more visually-depictable, variable data elements; and
a means for displaying the one or more visually-depictable, variable data elements, coupled to the means for processing.

28. The apparatus of claim 27, further comprising:
a means for outputting one or more audio clips identified in the file.

29. The apparatus of claim 27, further comprising:
a means for storing the one or more visually-depictable, variable data elements.

30. A system comprising:
a means for receiving campaign data, which defines a promotional campaign, and for generating a job document, based on the campaign data, wherein the job document identifies one or more visually-depictable, variable data elements;
a means for delivering a file, which includes information from the job document, to at least one means for rendering;
the at least one means for rendering the file, wherein a means for rendering includes a means for displaying, and the at least one means for rendering is further for rendering the file by causing the means for displaying to display the one or more visually-depictable, variable data elements.

31. The system of claim 30, further comprising:
a means for producing the campaign data.

32. The system of claim 30, further comprising:
a means for applying one or more business rules to the campaign data prior to generating the job document.

33. A computer readable medium having program instructions stored thereon to perform a method, which when executed result in:
receiving an electronic document by a point-of-purchase rendering station, wherein the rendering station includes a display device, and wherein the electronic document identifies one or more variable data elements; and
rendering the electronic document by causing the display device to display the one or more variable data elements.

34. The computer readable medium of claim 33, wherein executing the program instructions further results in:
downloading and storing the one or more variable data elements.

35. The computer readable medium of claim 33, wherein executing the program instructions further results in:
translating the electronic document into a portable document format, prior to rendering.

36. A computer readable medium having program instructions stored thereon to perform a method, which when executed result in:
receiving campaign data, which defines a promotional campaign;
generating multiple job documents, based on the campaign data, wherein at least some of the multiple job documents identify one or more visually-depictable, variable data elements; and
delivering multiple files, which include information from the multiple job documents, to multiple rendering stations for rendering on display devices associated with the rendering stations.

37. The computer readable medium of claim 36, wherein generating the multiple job documents comprises generating the multiple job documents so that at least some of the multiple job documents include multimedia content.

38. The computer readable medium of claim 36, wherein generating the multiple job documents includes generating multiple personalized printing markup language templates, and wherein the multiple files include the multiple personalized printing markup language templates.

39. The computer readable medium of claim 36, wherein generating the multiple job documents comprises generating multiple personalized printing markup language templates.

40. The computer readable medium of claim 39, wherein executing the program instructions further results in:
translating at least some of the multiple personalized printing markup language templates into one or more portable document format files, wherein the multiple files include the one or more portable document format files.
